(19) United States
(12) Patent Application Publication
(10) Pub. No.: US 2002/0105508 A1
(43) Pub. Date: Aug. 8, 2002

(54) Display device

(76) Inventor: Toshiya Inada, Kobe City (JP)

Correspondence Address: U.S. Philips Corporation, 580 White Plains Road, Tarrytown, NY, 10591, US

(21) Appl. No.: 10/060,678

(22) Filed: Jan. 30, 2002

(30) Foreign Application Priority Data
Feb. 2, 2001 (JP) 2001-27509

(51) Int. Cl. G09G 5/00

(52) U.S. Cl. 345/204

(57) ABSTRACT

In an active matrix LCD, a group of gate lines are formed with input wires (31a) and drive wires (31b), both wires being electrically connected each other. The input wires (31a) extend in the vertical direction which is the same as the data lines (32), while the drive wires (31b) extend in the horizontal direction. Thus, electrical connections between the data lines (32) and the data line IC chip (21), and electrical connections between the gate lines (31a, 31b) and the gate line IC chip (22) are provided at the top and the bottom of the display device, respectively, with the liquid crystal panel 10 being interposed therebetween. As a result, the device can be realized in which a width in the horizontal direction is narrower than the conventional device.

### BACKGROUND OF THE INVENTION

1. Field of the Invention

The present invention relates to a display device comprising a display portion having an array of pixels arranged in a matrix, a group of first wires each formed for a corresponding row of pixels of the pixel array for supplying a first voltage to electrodes of the pixels of the corresponding row, a group of second wires each formed for a corresponding column of pixels of the pixel array for supplying a second voltage to electrodes of the pixels of the corresponding column, first voltage supplying means each electrically connected to a corresponding one of the first wires for permitting the first voltage to be supplied thereto, and second voltage supplying means each electrically connected to a corresponding one of the second wires for permitting the second voltage to be supplied thereto.

2. Description of the Related Art

Recently, electronic equipment having a flat-panel display, such as a liquid crystal display (LCD), a plasma display panel (PDP), a field emission display (FED) and an organic electroluminescent display (ELD), has come into common use as a display device. The electronic equipment having a liquid crystal display, in particular, is becoming widespread and has various applications.

For the liquid crystal display, one having a panel of the transmission-type, which causes a light from a light source (backlight) disposed behind the panel to pass through a filter thereby to perform a display, was in the mainstream in the past. Lately, attention is being given to the display having a panel of the reflection-type, which carries out a display, without the need for the backlight, by reflecting an incident light through a surface of the panel by a reflective electrode and then passing the reflected light through a filter. The reflection-type liquid crystal panel has the advantages in its higher resolution, higher brightness, lower power consumption and less susceptibility to flushout by the surrounding light. As a result, its market expansion is expected for applications to devices for outdoor use, such as mobile phones or PDA (personal digital assistants), this leading to increasing need for its miniaturization.

FIG. 1 diagrammatically shows an exemplary structure of a conventional liquid crystal display apparatus. FIG. 2 shows a partial structure of a driving circuit of the liquid crystal display on an enlarged scale. The liquid crystal display apparatus comprises a liquid crystal panel 110 with a display portion 110a and a driving section 120 arranged around the liquid crystal panel 110.

The liquid crystal panel 110 comprises a driving substrate and an opposite substrate disposed opposite to the driving substrate. The driving substrate is provided with a plurality of pixel electrodes 113 arranged in a matrix with M rows and N columns, thin film transistors (referred to as “TFT” in the following description) 117 for controlling a respective one of the pixel electrodes 113, respectively, and so on formed thereon. The opposite substrate is provided with a color filter, a common electrode and so on formed thereon. A liquid crystal layer is held between these substrates. The driving substrate is formed, in correspondence with the pixel electrodes 113 of M columns by N rows, with M gate lines (scanning lines) 131 usually extending in the horizontal direction and N data lines (source lines) 132 usually extending in the vertical direction. Gate electrodes of the predetermined TFTs 117 are electrically connected to a corresponding gate line 131, and each of the gate lines 131 is provided with a terminal 134 at its end. Source electrodes of the predetermined TFTs 117 are electrically connected to a corresponding data line 132. A terminal 133 is provided at an end of each of the data lines 132 as in the case of the gate lines 131.

The driving section 120 comprises a gate line IC chip for driving the gate lines 131, each of terminals 122 of the IC chip being electrically connected to a respective one of terminals 134 of the gate lines 131. The driving section 120 also comprises a data line IC chip for driving the data lines 132, each of terminals 121 of the IC chip being electrically connected to a respective one of terminals 133 of the data lines 132.

In the liquid crystal display apparatus with such a configuration, scanning voltages are supplied sequentially and cyclically from the terminals 122 of the gate line IC chip to the terminals 134 of the gate lines 131. On the other hand, signal voltages are supplied selectively in response to an image signal from the terminals 121 of the data line IC chip to the terminals 133 of the data lines 132. A predetermined voltage is always supplied to the common electrode. The signal voltages are thus supplied to the pixel electrodes 113 through the TFTs which are rendered on by the application of the scanning voltage. Consequently, voltages are applied to the liquid crystal layer disposed between the common electrode and the pixel electrodes 113 to which the signal voltages are supplied, so that a desired image display is performed.

With the configuration described above, however, in most cases the gate lines extend in the horizontal direction while the data lines extend in the vertical direction as already mentioned, when the apparatus is disposed in such a way that the image display can be seen properly. In that case, the voltages supplied to the terminals of the gate lines are entered from the left or right side of the display panel while the voltages supplied to the terminals of the data lines are entered from the top or bottom side of the display panel. Therefore, a gate terminal area where the terminals of the gate lines and the gate line IC chip are present has been provided on the left or right side of the display panel, while a data terminal area where the terminals of the data lines and the data line IC chips are present has been provided on the top or bottom side of the display panel. In other words, the gate terminal area and the data terminal area have been provided in such directions that they intersect perpendicularly to each other. This causes a problem that the apparatus becomes larger. In particular, typical display devices are constituted in such a way that their length in the horizontal (right-and-left) direction is larger than that in the vertical (up-and-down) direction and that the terminal area exists on a side in the horizontal direction. The conventional display device cannot thus sufficiently meet the demands that the apparatus is miniaturized and that the width of the display portion is expanded in the horizontal direction.

### SUMMARY OF THE INVENTION

The invention has been made in view of the above-mentioned problems and has an object to provide a display device of the type described in the opening paragraph which can be miniaturized without reduction of a display area.

A display device according to the invention is characterized in that electric connections between the first wires and the first voltage supplying means, and electric connections between the second wires and the second voltage supplying means are provided on only one side or both sides of said pair of opposing edges.

With the display device according to the invention, a predetermined voltage is supplied from the first voltage supplying means to a first wire at one side of the pair of opposing edges of the display portion, based on which the first voltage is supplied from the first wire to respective pixels which constitute a row of pixels of the array. A predetermined voltage is supplied from the second voltage supplying means to a second wire at the one side or the other side of the pair of opposing edges, based on which the second voltage is supplied from the second wire to respective pixels which constitute a column of pixels of the array.

According to the display device of the invention, a reduction in size, in one direction, of the device is achieved without reducing its display area as compared with the case the said electric connections are present on the perpendicularly disposed sides of the device.

In the display device according to the invention, preferably, one of the groups of the first wires and the second wires comprises input wires each having an electric connection with the corresponding voltage supplying means and drive wires each electrically connected to said corresponding voltage supplying means through the corresponding input wire, the input wires and the other group of the first wires and the second wires extending in the same direction, the drive wires extending perpendicularly to the input wires. In this case, the predetermined voltage is supplied from the voltage supplying means corresponding to the wire having the input wire to the input wire, and then the voltage is supplied from the input wire to the drive wires.

In the display device according to the invention, preferably, one end of each input wire is an electric connection with the corresponding voltage supplying means and the other end is an electric connection with the corresponding drive wire, dummy wires, for adjusting electric capacitance of each pixel constituting said pixel array, being formed for other pixels than those of the pixels for which the input wires are present. All of capacitance of the pixels are made substantially uniform by means of these dummy wires, so that degradation of image quality of the display is prevented.

The dummy wires are connected, for example, to further wires which have the function of supplying a given voltage to the dummy wires. The dummy wires may alternatively be connected to the predetermined drive wires.

Preferably, at least part of the above-mentioned electrodes has the function of reflecting an incident light, and a picture is formed by a reflected light from the electrodes. This results in a realization of a display device with a higher resolution and a higher brightness.

Other and further objects, features and advantages of the invention will appear more fully from the following description.

### BRIEF DESCRIPTION OF THE DRAWINGS

FIG. 1 shows an essence of wires of a conventional display device.

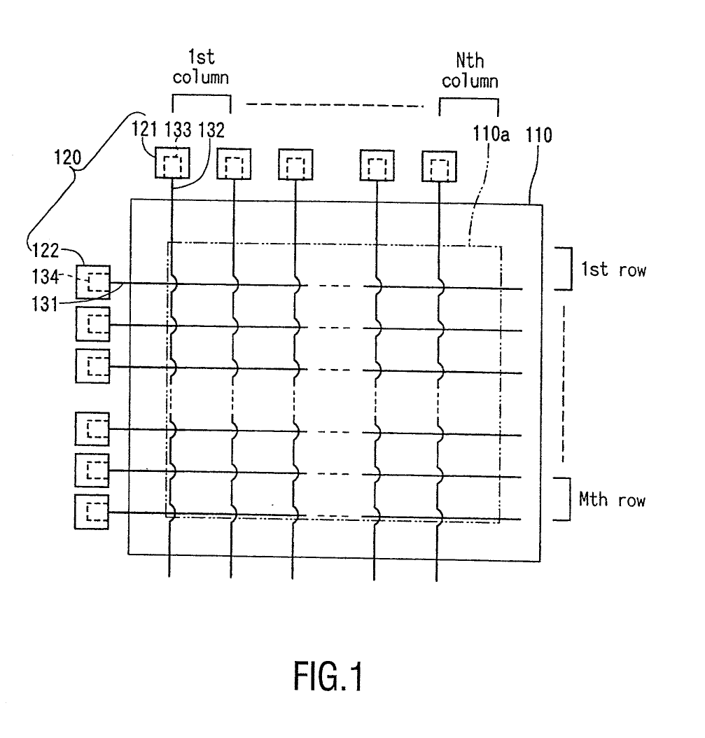

FIG. 2 shows an essence of a driving circuit of the conventional display device.

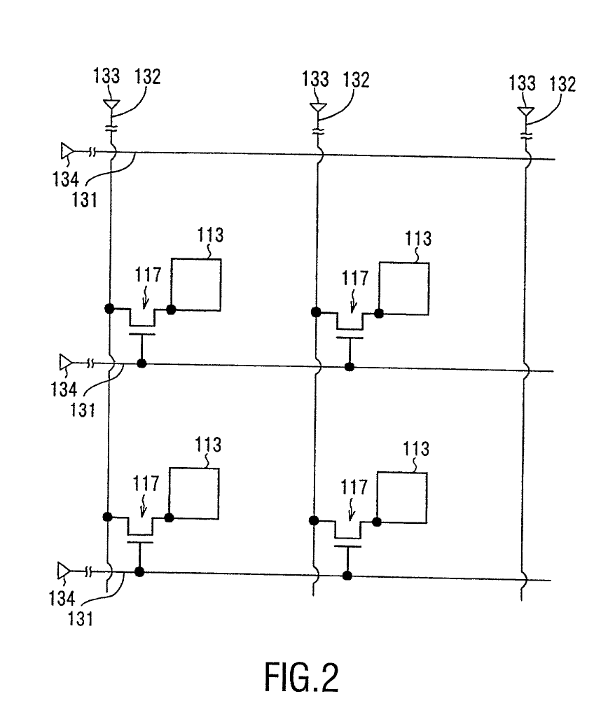

FIG. 3 is a cross section of a display device according to the first embodiment of the invention.

FIG. 4 shows an essence of wires of the display device illustrated in FIG. 3.

FIG. 5 shows an essence of a driving circuit of the display device illustrated in FIG.3.

FIG. 6 shows an essence of a driving circuit of a display device according to the second embodiment of the invention.

FIG. 7 shows an equivalent circuit of the display device according to the first embodiment of the invention.

FIG. 8 shows an equivalent circuit of the display device according to the second embodiment of the invention.

FIG. 9 shows an equivalent circuit of a display device according to the third embodiment of the invention.

FIG. 10 shows an equivalent circuit of a display device according to the fourth embodiment of the invention.

FIG. 11 shows an equivalent circuit of a display device according to the fifth embodiment of the invention.

FIG. 12 conceptually shows an essence of wires of a further display device according to the invention.

### DETAILED DESCRIPTION OF THE PREFERRED EMBODIMENTS

The embodiments of this invention will be described in further detail hereinafter with reference to the accompanying drawings.

[First Embodiment]

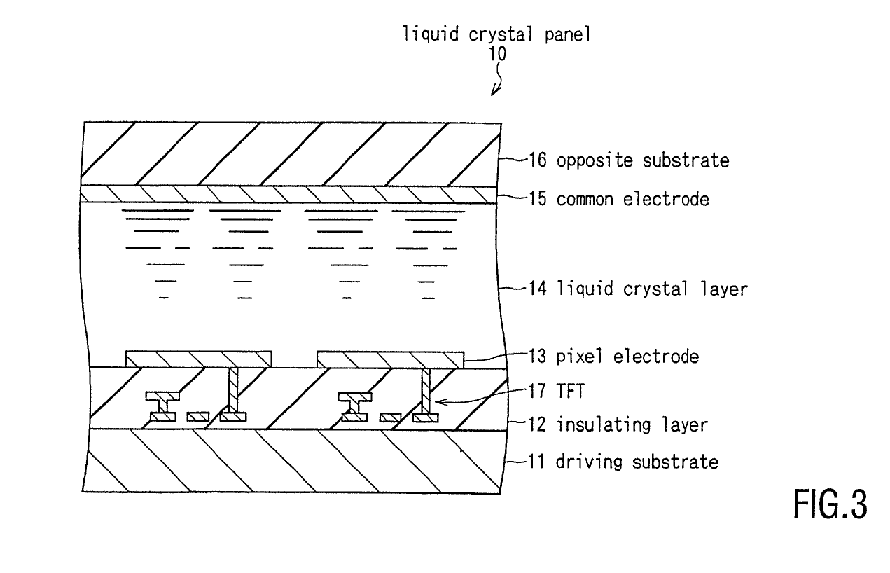

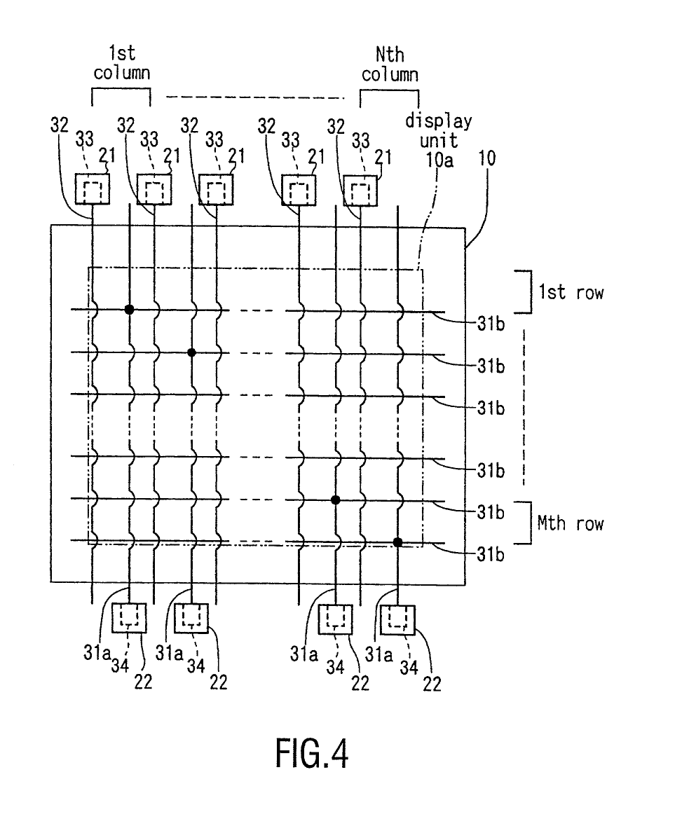

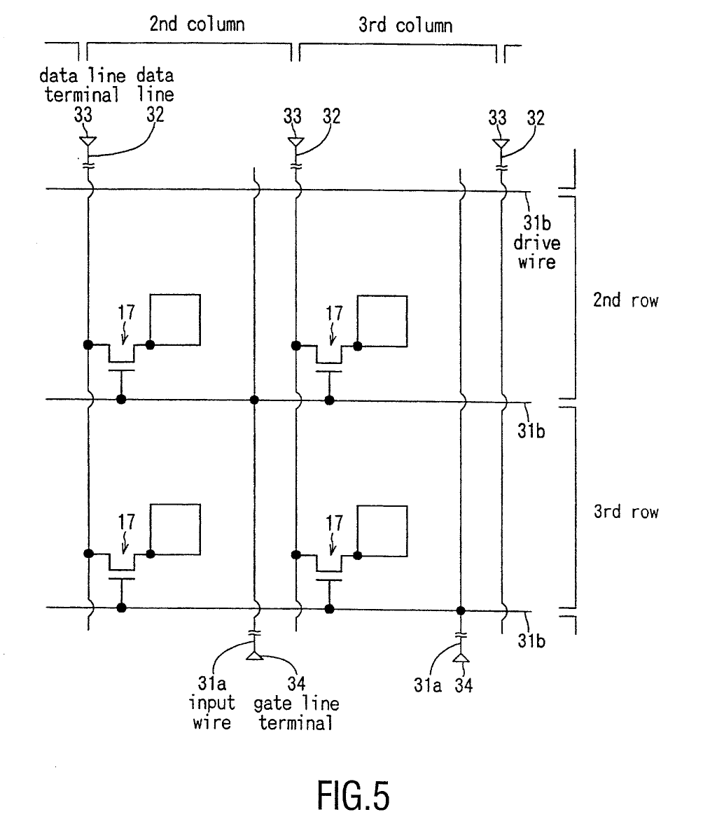

FIG. 3 diagrammatically shows a cross-section of a liquid crystal display apparatus (more specifically a liquid crystal panel 10 which will be described later) provided as a display device according to a first embodiment of the invention. FIG. 4 shows an essential structure of wires which is a characteristic part of the liquid crystal display apparatus according to the embodiment. FIG. 5 shows an essential structure of a driving circuit for the liquid crystal display apparatus according to this embodiment. The liquid crystal display apparatus comprises the liquid crystal panel 10 having a display portion 10a, and IC chips 21 and 22 (see FIG. 4) provided as a voltage supplying means disposed around the liquid crystal panel 10.

The liquid crystal panel 10 (the display portion 10a) comprises a driving substrate 11 and an opposite substrate 16. The driving substrate 11 is provided with an insulating layer 12 and a plurality of pixel electrodes 13, the insulating layer 12 being formed between the driving substrate 11 and the pixel electrodes 13. The opposite substrate 16 is arranged to oppose the driving substrate 11 with a given space in between and is provided with a common electrode 15 and a color filter (not shown) thereon. A liquid crystal layer 14 is held between the driving substrate 11 and the opposite substrate 16. Thus formed is a structure in which the display portion 10a has at least a pair of opposing edges. The pixel electrodes 13 are made of a material with a reflecting function such as aluminum (Al) and constitute sub-pixels which are arranged in a matrix with M rows and N columns. Each of the pixel electrodes 13 is electrically connected, for example, to a drain electrode of a respective TFT 17 as a switching element, the TFT 17 being formed in the insulating layer 12 in correspondence with the pixel electrode 13. Thus, this liquid crystal panel 10 is designed to be the reflective type. Either of a so-called top gate type TFT or a so-called bottom gate type TFT may be used as the TFT 17.

Gate electrodes of TFTs 17 which are arranged in a matrix correspondingly to the pixel electrodes 13 are electrically connected row by row to gate lines provided as first wires, i.e., driving wires 31b which will be described later. Source electrodes of TFTs 17 are electrically connected column by column to data lines 32 provided as second wires.

The pixel electrodes 13 are, in this case, arranged in a matrix with M rows and N columns as already mentioned, so that N data lines 32 extend in the column direction (vertical direction), which are formed in the insulating film 12. The data lines 32 are provided at one ends (in this case, top ends in FIGS. 4 and 5) with data line terminals 33. The data line terminals 33 are electrically connected, through an anisotropic conductive material, to output terminals 21 of a data line IC chip (a first voltage supplying means), which terminals are formed correspondingly to the respective data line terminals 33 on the same side as the place where said data line terminals 33 of the liquid crystal panel 10 (the display portion 10a) are formed. Thus, the electrical connections between the data lines 32 and the data line IC chip are located at the vertically upper part of FIGS. 4 and 5.

The gate lines comprise M input wires 31a and M drive wires 31b in correspondence with the pixel electrodes 13. The respective input wires 31a extend in the same direction as the data lines 32, which direction is vertical in this case, while the respective drive wires 31b extend in the column direction (horizontal direction) perpendicular to the input wires 31a. It is to be noted that said direction perpendicular to the input wires 31a includes any direction substantially perpendicular to the input wires 31a. Both the input wires 31a and the drive wires 31b are formed in the insulating layer. The input wires 31a and the drive wires 31b correspond to each other in a one-to-one relationship, the corresponding wires in each pair being electrically connected to each other through a not-shown contact hole (through hole) filled with a conductive material. Those of the input wires 31a and the drive wires 31b which do not correspond to each other are electrically insulated. The input wires 31a, the drive wires 31b, the contact holes and the data lines 32 are all provided between the electrodes 13 and the driving substrate 11, so that the display apparatus has an excellent optical property without the numerical aperture being reduced in this embodiment.

In the liquid crystal display apparatus, each area surrounded by two adjacent drive wires 31b and two adjacent data lines 32 corresponds to a respective one of sub-pixels which together form a pixel or a pixel array as the display portion. “A pixel” in the invention may include a sub-pixel.

Each of the input wires 31a is provided with a respective one of gate line terminals 34 at an end on the edge opposite to the side where the data line terminals are formed (the bottom edge of FIGS. 4 and 5 in this case). The respective gate line terminals 34 are electrically connected to output terminals 22 of a gate line IC chip (second voltage supplying means) each via, for example, an anisotropic conductive material, the output terminals 22 each being formed on the side same as that on which the input wires 31a of the liquid crystal panel 10 (the display portion 10a) are formed in correspondence with a respective one of the input wires. Thus, in this case, electrical connections between the gate lines 31a, 31b and the gate line IC chip are located at the lower part of FIGS. 4 and 5. In the liquid crystal display apparatus according to the embodiment, the electrical connections between the data lines 32 and the data line IC chip, and the electrical connections between the gate lines 31a, 31b and the gate line IC chip are provided on both of the pair of the opposing edges of the display portion 10a of the liquid crystal panel 10. More specifically, the gate line terminals 34 and the data line terminals 33 are provided at the top and the bottom of the display apparatus, respectively, with the liquid crystal panel 10 being interposed therebetween. As a result, a width of the liquid crystal display apparatus in the horizontal direction is narrower than the conventional one.

The liquid crystal display apparatus with the structure described above will operate as follows.

In the liquid crystal display apparatus, a predetermined voltage is always applied from a not-shown voltage circuit to the common electrode 15. The gate line IC chip supplies predetermined voltages to the input wires 31a at its electrical connections with the gate line terminals 34, which voltages being supplied to the drive wires 31b through the through holes. The gate lines 31a and 31b are thus permitted to supply voltages, and the voltages are supplied to the gate electrodes of the TFTs 17 through the through holes and the drive wires 31b. More specifically, one scanning pulse, as a gate voltage (first voltage), per one cycle is supplied to each of the corresponding row of gate electrodes of the TFTs 17, where said one cycle corresponds to one scanning selection period of time. When an on-level voltage is supplied to a gate electrode of each TFT 17, the TFT 17 is rendered on whereby the TFT is made conductive between its source electrode and drain electrode.

The data line IC chip receives an image signal from a not-shown voltage circuit and converts the received image signal into voltages in accordance with the signal. The data line IC chip then supplies the voltages to the data lines 32 at the electrical connections with the data line terminals 33. The data lines 32 are thus permitted to supply voltages and supply signal voltages (second voltages) to the source electrodes of the TFTs 17. The signal voltages are supplied to the corresponding pixel electrodes through the TFTs 17, when the TFTs 17 are in the on state. Consequently, voltages are applied to those parts of the liquid crystal layer 14 which are present between the common electrode 15 and the pixel electrodes 13 thus supplied with the signal voltages, so that the liquid crystal layer 14 is driven and an image is displayed on the display portion 10a.

With the liquid crystal display apparatus of this embodiment, since the electric connections between the data lines 32 and the data line IC chip, and the electric connections between the gate lines 31a, 31b and the gate line IC chip are provided, respectively, on both sides of the apparatus which oppose to each other via the display portion 10a of the liquid crystal panel 10 in the vertical direction, a terminal forming area is unnecessary on both sides of the apparatus in the horizontal direction. Therefore, the apparatus can be reduced in size in one direction without reducing its display area as compared with the case where said electric connections are present on the perpendicularly disposed sides of the apparatus.

[Second Embodiment]

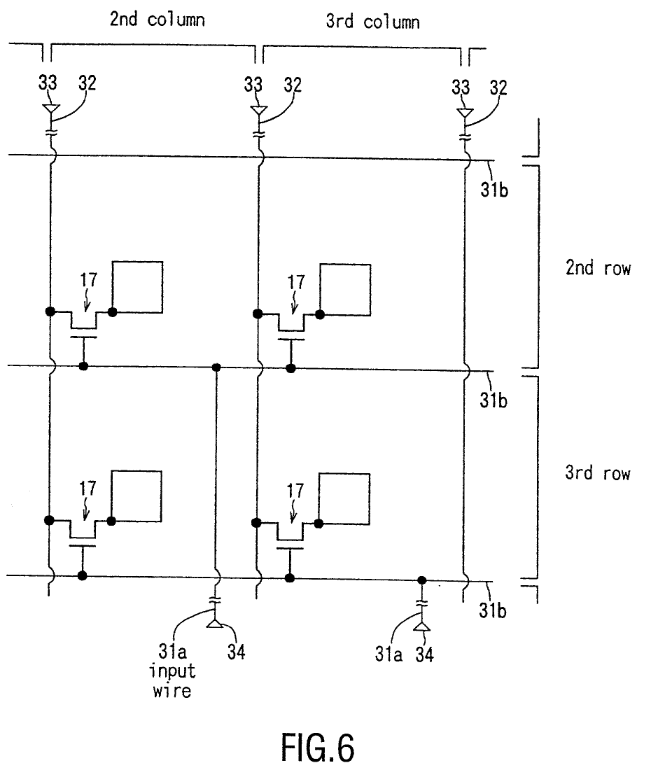

FIG. 6 shows an essential structure of a driving circuit for a liquid crystal display apparatus provided as a display device according to a second embodiment of the invention. This liquid crystal display apparatus is the same in structure as that according to the first embodiment except for the configuration of the input wires 31a. Therefore, the input wires 31a will only be described in detail hereinafter.

N input wires 31a are provided in the insulating layer 12, in correspondence with the pixel electrodes, to extend in the same direction as the data lines 32. Each of the input wires 31a is provided with a respective one of the gate line terminals 34 at the end on the side of the apparatus opposite to the side where the data line terminals 33 are formed.□□The input wires 31a correspond to the drive wires 31b one by one, wherein each of the input wires 31a is electrically connected to the corresponding drive wire 31b, but is insulated from other drive wires 31b. FIG. 6 only shows the input wires 31a associated with the second and the third rows.

A big difference exists in length (patterning) between the input wires 31a of this embodiment and those of the first embodiment. More specifically, each of the other ends of the input wires 31a (the ends opposite to the ends provided with the gate line terminals 34) is a junction between the corresponding input wire 31a and the corresponding drive wire 31b, each input wire 31a of this embodiment, thus, being formed in a such a manner that the portion of the input wire 31a of the previous embodiment extending further from the junction with the drive wire 31b is cut away. In this case, it should be understood that said junctions between the input wires 31a and the drive wires 31b mean the portions where the input wires 31a and the drive wires 31b are physically connected via contact holes.

With this embodiment, the apparatus can be reduced in size in one direction without reducing its display area as the first embodiment. Moreover, since each of the other ends of the input wires 31a is the junction with a respective one of the drive wires 31b , the number of crossings of the input wires 31a and the drive wires 31b over the entire display portion can be decreased. Therefore, the power consumption of the liquid crystal panel 10 can be reduced.

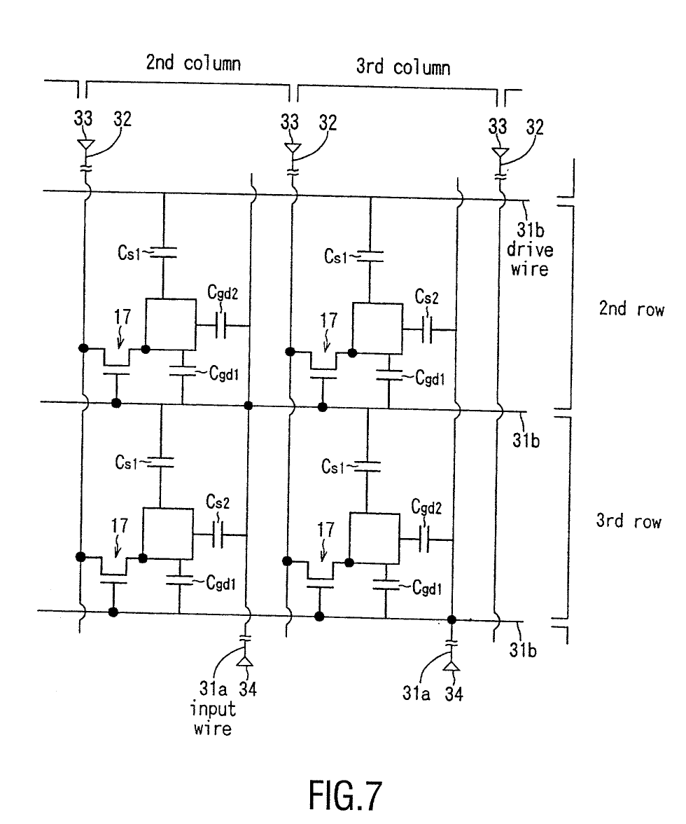

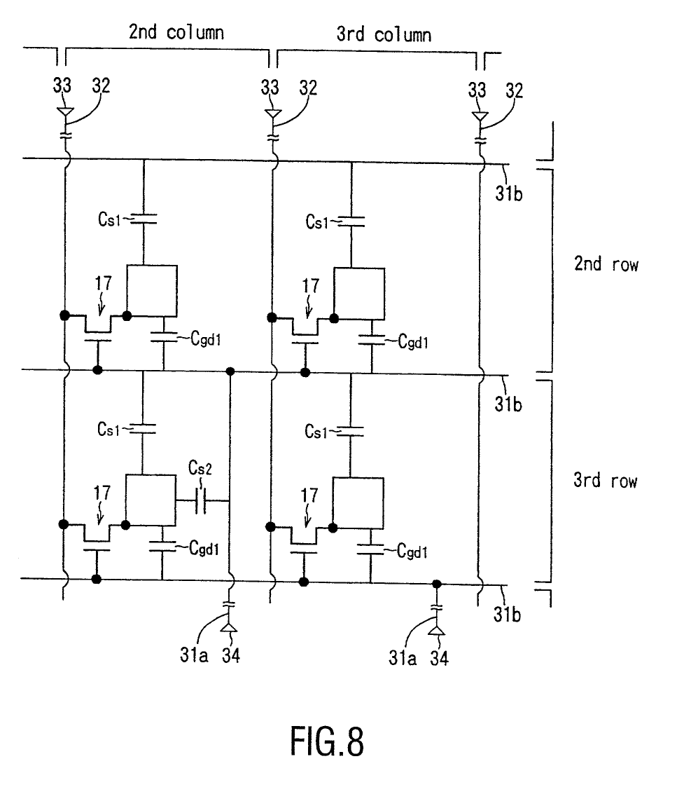

An electrical capacitance is present in each sub-pixel because it is provided with the gate line 31a and 31b, the data line 32, the electrodes and so on. FIGS. 7 and 8 show equivalent circuits of the liquid crystal display apparatuses according to the first and the second embodiments, respectively. Formed as electrical capacitance for each sub-pixel are, for example, storage capacitance Cₛ (each storage capacitance Cₛ₁ is formed between the pixel electrode 13 and the drive wire 31b) and parasitic capacitance C_{gd} (each parasitic capacitance C_{gd1} is formed between the gate electrode of the TFT 17 and the drive wire 31b to which said gate electrode is electrically connected.) in addition to pixel capacitance C_{LC} (not shown). All of capacitance in each sub-pixel should be substantially identical, when the sub-pixels have to have same brightness with respect to one another. Coupling capacitance may be present between the adjacent pixel electrodes, but such a coupling capacitance has no influence on a kick-off voltage which will be described later.

In the first embodiment, storage capacitance Cₛ₂ is formed between the pixel electrode and the input wire 31a at the pixel defined by the second row and the third column, as is apparent from FIG. 7, and the same holds true for the pixel defined by the third row and the second column. The storage capacitance Cₛ₂ is formed, when a voltage to be supplied to the input wire 31a present in the relevant pixel and a voltage to be supplied to the gate electrode of the relevant TFT 17 are different. Thus, for example, in the case of the pixel defined by the second row and the third column, since the gate voltage is supplied from the input wire 31a provided in the area of the second column to the gate electrode, this gate voltage is different from the voltage which is supplied to the input wire 31a provided in the area of the third column, whereby the storage capacitance Cₛ₂ is formed.

At each of the pixels defined by the second row and the third column, and by the third row and the second column, respectively, parasitic capacitance C_{gd2} is formed between the pixel electrode and the input wire 31a. The parasitic capacitance C_{gd2} is formed, when the voltage to be supplied to the input wire 31a present in the relevant pixel and the voltage to be supplied to the gate electrode of the relevant TFT 17 are equal. Thus, for example, in the case of the pixel defined by the second row and the second column, since the gate voltage is supplied from the input wire 31a provided in the area of the second column, this gate voltage is equal to the voltage which is supplied to the input wire 31a present in the relevant pixel, whereby the parasitic capacitance C_{gd2} is formed.

In the operation of the liquid crystal display, when a TFT 17 is rendered off, the pixel electrode 13 corresponding thereto is, ideally, electrically insulated from the TFT. However, actually, the pixel electrode 13 is influenced by a voltage induced on the gate electrode due to the parasitic capacitance C_{gd1} and C_{gd2}. More specifically, when the TFT 17 changes from the on state to the off state, the voltage of the pixel electrode is changed by a voltage ΔV_{c} (referred to as a “kick-off voltage” hereinafter) represented by the following mathematical formula (1) (a penetration phenomenon or a field through phenomenon). Since degradation in image quality occurs when the voltage changes at the pixel electrodes are different in the display portion 10a, it is preferable that the occurrence of a difference between the voltages ΔV_{c} in the display portion 10a be prevented.

ΔV_{c}=C_{gd}/(C_{gd}+Cₛ+C_{LC})×ΔV_{G} (1)

where ΔV_{G} is a difference between the gate voltage at the on level and that at the off level,

Cₛ=Cₛ₁+Cₛ₂, and C_{gd}=C_{gd1}+C_{gd2}.

In the second embodiment (FIG. 8), the parasitic capacitance C_{gd2} is not formed because that part of the each input wire 31a which extends further from the junction with the drive wire 31b is not present, while the storage capacitance C_{S2} is not also formed in each sub-pixel in which the input wire 31a is not present. As a result, a difference in the storage capacitance C_{S} exists among the sub-pixels, so that a difference of the kick-off voltage ΔV_{c} will occur.

Several ways of wiring will now be described in which an occurrence of the difference in the kick-off voltage ΔV_{c} among the sub-pixels can be prevented.

[Third Embodiment]

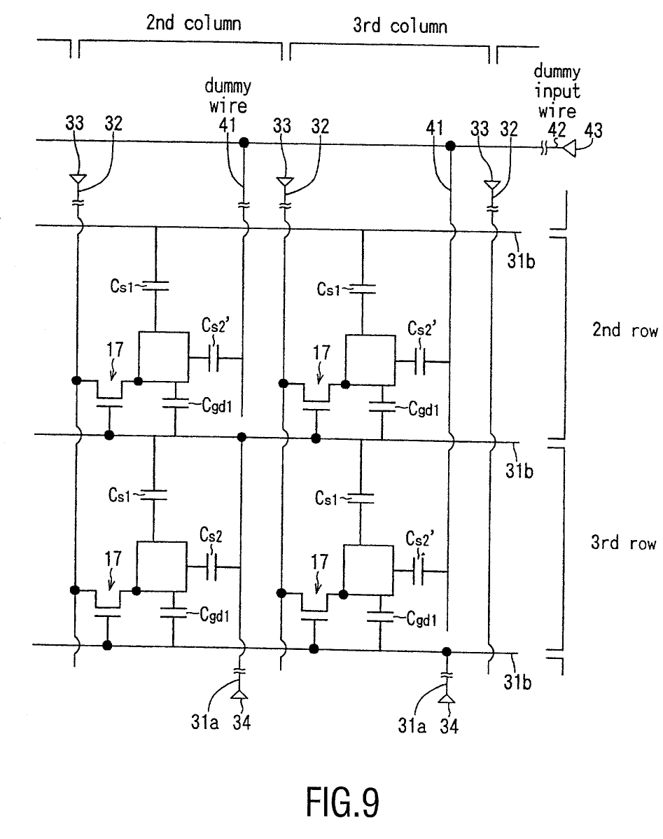

FIG. 9 shows an essential structure of a driving circuit for a liquid crystal display apparatus provided as a display device according to a third embodiment of the invention. This liquid crystal display apparatus is the same in structure as that according to the second embodiment except that it further comprises dummy wires 41 and a dummy input wire 42 for supplying voltages to the dummy wires 41. Therefore, a detailed description of the corresponding parts will be omitted.

The dummy wires 41 are formed to adjust the electrical capacitance at the respective sub-pixels for the purpose of preventing the occurrence of the difference in the kick-off voltage ΔV_{c} among the sub-pixels as mentioned above. A pattern of dummy wires may be designed in various ways. In the example shown in FIG. 9, each dummy wire 41 is provided in each column for those sub-pixels for which no input wire 31a is present, that is to say, each dummy wire 41 is formed to extend, for example, in alignment with a corresponding input wire 31a from a point after its junction with the drive wire 31b seen from the side of the gate line terminal. The dummy wires 41 are electrically connected to the dummy input wire 42 extending in the same direction as the drive wires 31b, for example, outside the display portion. Each dummy wire 41 is electrically insulated from the corresponding input wire 31a.

The dummy input wire 42 is provided at its one end with a terminal 43. Predetermined voltages such as the voltage to be supplied to the common electrode and the off-level voltages to be supplied to the gate electrodes of the TFTs 17 are supplied to the dummy input wire 42 via the terminal 43. The voltage supplied to the dummy input wire 42 is not especially limited, but it is necessary that the dummy input wire 42 is connected to any already-existing voltage source instead of a new voltage source to accurately form storage capacitance Cₛ₂′ which will be described later. Therefore, the voltage supplied to the common electrode, the off-level voltages supplied to the gate electrodes of the TFTs 17 as mentioned above and so on are suitable since they are necessarily supplied to the liquid crystal panel. In this case, although the terminal 43 is formed on the right hand of the panel, the terminal may be formed, of course, on the upper or the lower sides of the panel.

With this wiring pattern, the storage capacitance Cₛ₂ is formed between the pixel electrode and the input wire 31a at the pixel defined by the third row and the second column as in the second embodiment. In each of the other three sub-pixels, storage capacitance Cₛ₂′ which has the same capacitance as the storage capacitance Cₛ₂ is formed between the pixel electrode and the dummy wire 41 because the pixel electrode and the dummy wire 41 are opposed. Such storage capacitance Cₛ₂ or Cₛ₂′ is formed in each of other sub-pixels than said four sub-pixels in a similar manner, so that the kick-off voltages ΔV_{c} in all the pixels are substantially equal by pattering the dummy wires 41 in this way.

With the liquid crystal display apparatus of this embodiment, since electrical capacitance in the sub-pixels are adjusted by providing the dummy wires 41 to form the storage capacitance Cₛ₂′ in those sub-pixels in which the storage capacitance Cₛ₂ are not formed, the effect can be obtained that the kick-off voltages ΔV_{c} at the sub-pixels are made substantially equal in addition to the effects of the first embodiment. Therefore, degradation of image quality such as a flicker and a burn-in on the liquid crystal panel can be prevented.

[Fourth Embodiment]

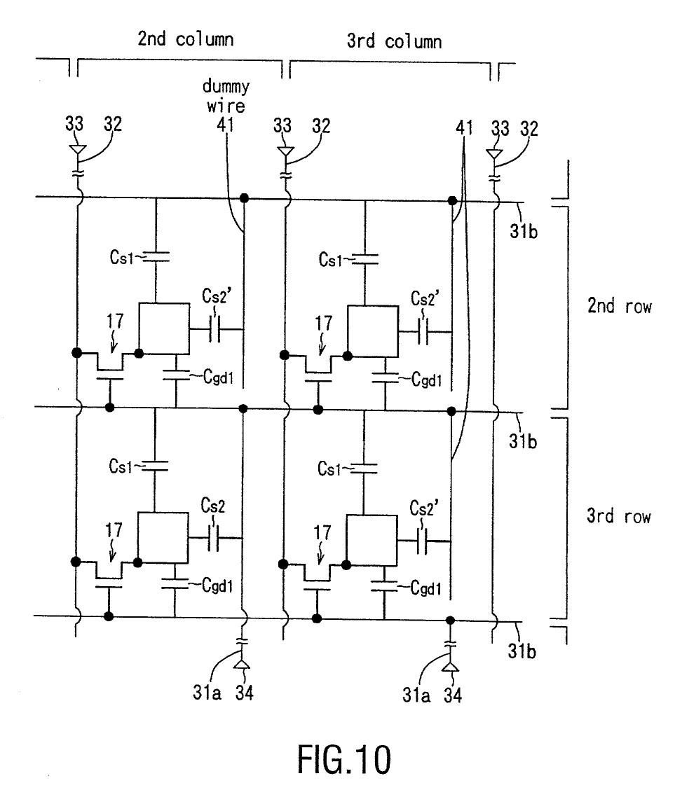

FIG. 10 shows an essential structure of a driving circuit for a liquid crystal display apparatus provided as a display device according to a fourth embodiment of the invention. This embodiment relates to a wiring manner in the case of adjusting capacitance of each pixel by using dummy wires as in the third embodiment.

In this embodiment, each dummy wire 41 is provided in every sub-pixel to extend, for example, in alignment with a corresponding input wire 31a from a point after its junction with the drive wire 31b seen from the side of the gate line terminal. Each dummy wire 41 is electrically connected to the drive wire 31b associated with a row which is the previous one with respect to the row corresponding to the relevant sub-pixel (i.e. the row in which the corresponding TFT is connected)

With this wiring pattern, the storage capacitance Cₛ₂ is formed between the pixel electrode and the input wire 31a at the sub-pixel defined by the third row and the second column, and the storage capacitance Cₛ₂′ which has the same capacitance as that of said sub-pixel is formed between the pixel electrode and the dummy wire 41 at each of the other three sub-pixels, as in the third embodiment.

With the liquid crystal display apparatus of this embodiment, an effect in which degradation of image quality is prevented can be obtained in addition to the effects of the first embodiment as in the third embodiment. Further, since there is no need for providing an extra input wire to supply voltages to the dummy wires, the apparatus can be a simpler structure. Moreover, since the dummy wires 41 do not cross over the drive wires 31b, a possibility that a defect is caused with a destruction of the insulating layer (FIG. 3) is eliminated, thereby the apparatus with high reliability can be realized.

In the fourth embodiment, the gate line terminals 34 are located at the lower part, and each dummy wire 41 is electrically connected to the drive wire 31b associated with a row which is the previous one with respect to the row corresponding to the relevant sub-pixel. However, the gate line terminals 34 may alternatively be located at the upper part, and each dummy wire 41 may alternatively be electrically connected to the drive wire 31b associated with a row which is the next one with respect to the row corresponding to the relevant sub-pixel. In such a case, a structure of a circuit is the one in which the circuit shown in FIG. 10 is turned upside down.

[Fifth Embodiment]

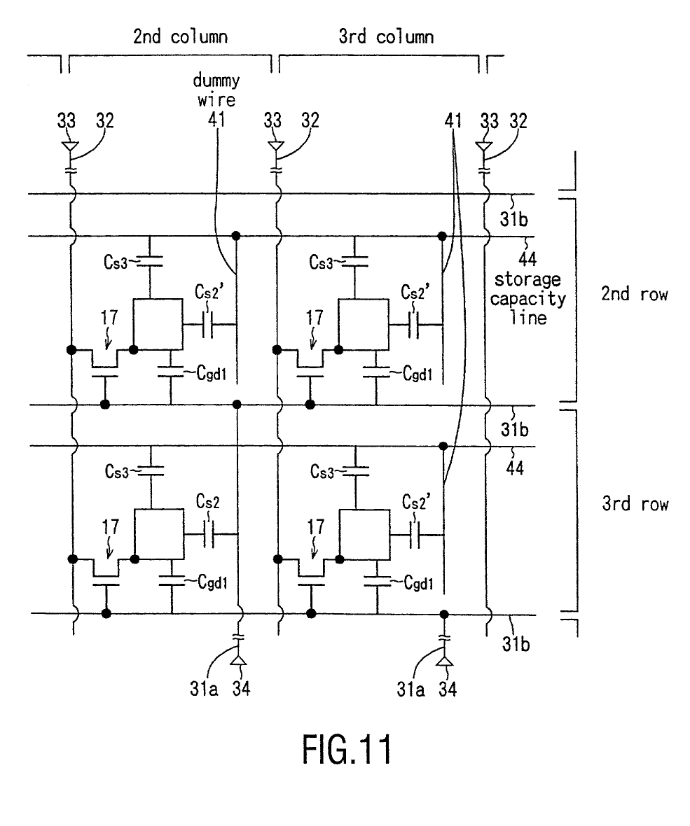

FIG. 11 shows an essential structure of a driving circuit for a liquid crystal display apparatus provided as a display device according to a fifth embodiment of the invention. This embodiment also relates to a wiring manner in the case of adjusting capacitance of each pixel by using dummy wires as in the third and the fourth embodiments.

In the first to fourth embodiments, the storage capacitance Cₛ₁ is formed using a so-called Cₛ on-gate structure in which the storage capacitance is superimposed on the gate electrode of the TFT 17. In this embodiment, however, the storage capacitance Cₛ₁ is formed using a so-called Cₛ, independent structure in which extra, special wires (storage capacitance lines 44) are provided. Each storage capacitance line 44 is provided in every row of the pixel array to extend in the same direction as the drive wire 31b to which predetermined voltages, such as a voltage to be supplied to the common electrode and a off-level voltages to be supplied to the gate electrodes of the TFTs 17, are supplied.

Each dummy wire 41 is provided in every sub-pixel to extend, for example, in alignment with a corresponding input wire 31a from a point after its junction with the drive wire 31b seen from the side of the gate line terminal. Each dummy wire 41 is electrically connected to the storage capacitance line 44 associated with the corresponding row.

With this wiring pattern, a storage capacitance Cₛ₃ is formed between the pixel electrode and the storage capacitance line 44 at each sub-pixel. The storage capacitance Cₛ₂ is formed between input wire 31a and the pixel electrode 13 at the sub-pixel defined by the third row and the second column, and the storage capacitance Cₛ₂′ which has the same capacitance as that of said sub-pixel is formed between the dummy wire 41 and the pixel electrode 13 at each of the other three sub-pixels.

With this embodiment, an effect in which degradation of image quality is prevented can be obtained in addition to the effects of the first embodiment as in the third and the fourth embodiments. Moreover, the apparatus with high reliability can be realized as in the fourth embodiment.

Although the invention has been described with reference to the embodiments thereof, it will be understood that the invention is not limited to the above-mentioned embodiments but can be modified differently. For example, the case where the electric connections between the data lines 32 and the data line IC chip, and the electric connections between the gate lines 31a, 31b and the gate line IC chip are provided, respectively, on both sides of the apparatus which oppose to each other via the display portion 10a of the liquid crystal panel 10 in the vertical direction has been described in the above-mentioned embodiments. However, said different electric connections may be provided, respectively, on both sides or on one side of the apparatus which oppose to each other via the display portion 10a of the liquid crystal panel 10 in the horizontal direction.

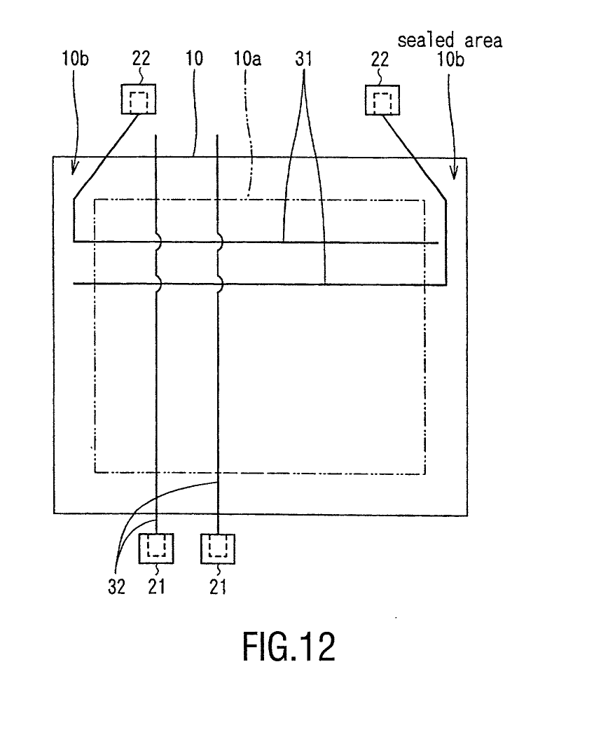

Although the case where the gate lines comprise the input wires 31a and the drive wires 31b has been described in the above-mentioned embodiments, the gate lines may not always comprise both wires. For example, as is diagrammatically shown in FIG. 12, when the gate lines 31 extend horizontally in the display portion 10a, electrical connections between the gate lines 31 and the gate line IC chip may be provided at the upper part of the display portion 10a, and gate lines 31 are also adapted to extend horizontally in the display portion 10a using, for example, a sealed area 10b other than the display portion 10a of the display panel.

The case where the electric connections associated with the gate lines and the electric connections associated with the data lines are provided, respectively, at the positions opposed via the display portion 10a has been described in the above-mentioned embodiments. However, these may be provided on only one side of the pair of opposing edges.

Although the case where the first wires are the gate lines and the second wires are the data lines has been described in the above-mentioned embodiments, the same holds true for a case where the first wires are the data lines and the second wires are gate lines.

Although the TFTs are used as a switching element in the above-mentioned embodiments, a different kind of the switching element such as a MOSFET may be used. Although the storage capacitance Cₛ₁ are formed in association with the so-called C_{S} on-gate structure in the first to fourth embodiments, the storage capacitance Cₛ₁ may alternatively be formed in association with the so-called C_{S} independent structure as is described in the fifth embodiment. Moreover, although the above-mentioned embodiments has described the apparatus with a so-called active matrix driving system in which switching elements are used, the invention is applicable to an apparatus with a so-called passive matrix driving system in which switching elements are not used.

Although the reflective type liquid crystal panel 10 in which the pixel electrodes have a reflecting function is used in the above-mentioned embodiments, a liquid crystal panel with other construction such as a transmissive type one may alternatively be used. Also, a liquid crystal panel with a mixed construction of a reflective part and a transmissive part (referred to a “transflective type”) may be used.

Although the case where the opposite substrate 16 is provided with the not-shown color filter has been described in the above-mentioned embodiments, the color filter may not be always formed.

Although the liquid crystal display apparatus is given as an example of a display device in the above-mentioned embodiments, the present invention is widely applicable to a display device with other construction which has an pixel array arranged in a matrix. Such a display device may be, for example, a plasma display panel, a field emission display or an organic electroluminescent display.

1. A display device comprising:
a display portion having at least a pair of opposing edges and an array of pixels arranged in a matrix;
a group of first wires each formed for a corresponding row of pixels of the pixel array for supplying a first voltage to electrodes of the pixels of the corresponding row;
a group of second wires each formed for a corresponding column of pixels of the pixel array for supplying a second voltage to electrodes of the pixels of the corresponding column;
first voltage supplying means each electrically connected to a corresponding one of the first wires for permitting the first voltage to be supplied thereto; and
second voltage supplying means each electrically connected to a corresponding one of the second wires for permitting the second voltage to be supplied thereto,
characterized in that electric connections between the first wires and the first voltage supplying means, and electric connections between the second wires and the second voltage supplying means are provided on only one side or both sides of said pair of opposing edges.

2. A display device as claimed in claim 1, characterized in that one of the groups of the first wires and the second wires comprises input wires each having an electric connection with the corresponding voltage supplying means and drive wires each electrically connected to said corresponding voltage supplying means through the corresponding input wire, the input wires and the other group of the first wires and the second wires extending in the same direction, the drive wires extending perpendicularly to the input wires.

3. A display device as claimed in claim 2, characterized in that one end of each input wire is an electric connection with the corresponding voltage supplying means and the other end is an electric connection with the corresponding drive wire, dummy wires, for

4. A display device as claimed in claim 3, characterized in that the dummy wires are connected to further wires which has the function of supplying a given voltage to the dummy wires.

5. A display device as claimed in claim 3, characterized in that the dummy wires are connected to the predetermined drive wires.

6. A display device as claimed in any one of claims 1 to 5, characterized in that at least part of the electrodes of the pixels has the function of reflecting an incident light, and a picture is formed by a reflected light from the electrodes.
